(19) United States
(12) Patent Application Publication
(10) Pub. No.: US 2026/0358894 A1
(43) Pub. Date: Nov. 12, 2026

(54) Locomotion Using Hand-Tracked Input for Extra Reality Environments

(71) Applicant: Meta Platforms Technologies, LLC, Menlo Park, CA (US)

(72) Inventors: Jonathan MALLINSON, Chester (GB); William Arthur Hugh STEPTOE, London (GB); Michael James LEBEAU, Amsterdam (NL); Steven James WILSON, Seattle, WA (US); Ethan MILLER, London (GB); Fábio RESENDE, San Francisco, CA (US)

(21) Appl. No.: 19/202,424

(22) Filed: May 8, 2025

(51) Int. Cl. G06F 3/01; G06F 3/04817; G06F 3/0486

(52) U.S. Cl. CPC G06F 3/017; G06F 3/013; G06F 3/04817; G06F 3/0486

(57) ABSTRACT

Aspects of the present disclosure provide locomotion for a representation of a user (e.g., an avatar) in an extra reality (XR) environment via hand-tracked input relative to a visual affordance, such as a visual hoop placed at the representation's feet. When the user looks down toward their feet with the XR system, the visual affordance can appear, e.g., with a movement icon and turn arrows. Using hand gestures, the user can A) grab, drag, and release the visual affordance (via the icon) to move to that location, B) pinch and release on the left or right arrows to turn a default amount (e.g., 30 degrees), and/or C) pinch, drag, and release the length of the arrows to turn a specified amount.

### TECHNICAL FIELD

The present disclosure is directed to providing locomotion of a representation of a user in an extra reality (XR) environment using hand-tracked input, such as gestures.

### BACKGROUND

Extra reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an extra reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing locomotion in an extra reality (XR) environment using hand-tracked input.

FIG. 6A is a conceptual diagram illustrating an example view, from an XR system, of a virtual hoop displayed in response to a user looking downward.

FIGS. 6B-6C are conceptual diagrams illustrating example views, from an XR system, of a representation of a user changing position in an XR environment by moving a virtual hoop.

FIG. 6D is a conceptual diagram illustrating an example view, from an XR system, of a representation of a user interacting with a virtual hoop to change orientation in an XR environment.

FIG. 6E is a conceptual diagram illustrating an example view, from an XR system, of a preview of a position and orientation of a representation of user relative to a virtual object based on interaction with a virtual hoop.

FIG. 6F is a conceptual diagram illustrating an example view, from an XR system, of a suggested position and orientation of a representation of a user relative to a virtual object based on interaction with a virtual hoop.

FIGS. 7A-7C are block diagrams illustrating overhead views of a representation of a user changing position in an XR environment by moving a virtual hoop.

FIGS. 8A-8C are conceptual diagrams illustrating overhead views of a representation of a user changing orientation in an XR environment by interacting with a virtual hoop.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure provide locomotion for a representation of a user (e.g., an avatar) in an extra reality (XR) environment via hand-tracked input relative to a visual affordance, such as a visual hoop placed at the representation's feet. When the user looks down toward their feet with the XR system, the visual affordance can appear, which can include a movement icon and turn arrows. Using hand gestures, the user can A) grab, drag, and release the visual affordance (via the icon) to move to that location, B) pinch and release on the left or right arrows to turn a default amount (e.g., 30 degrees), and/or C) pinch, drag, and release the length of the arrows to turn a specified amount in the XR environment. In some implementations, more advanced users need not look down at their feet to trigger display and control of the visual affordance, and can instead simply bring the hand close to the body.

In some implementations, the XR locomotion system can integrate with “hot spots,” e.g., pre-designated locations in the XR and/or real-world environment, such as points on or near virtual objects, physical objects, commonly accessed points in the real-world and/or XR environment (e.g., by the user, by other users of XR systems generally, and/or by similarly situated users), and/or the like. In some implementations, when a user drags-and-holds the visual affordance within a threshold distance of a hot spot (e.g., 1 meter), the XR locomotion system can display a preview of the representation of the user at that hot spot, rather than at the requested location. If the hot spot is already occupied, e.g., with one or more physical and/or virtual objects (e.g., an avatar of another user), the XR locomotion system can display a preview of the representation of the user at another location with a threshold distance of the hot spot, e.g., the closest available hot spot to the occupied hot spot, such that the user(s) do not feel crowded in the XR environment. Upon release of the visual affordance, the XR locomotion system can move the representation to the hot spot, providing a viewpoint into the XR environment from the location and/or orientation of the hot spot.

As described herein, the term “locomotion” or “locomotive action” generally refers an instruction, action, or input to modify a representation's (e.g., avatar's) position and/or orientation within an XR environment. In some cases, the representation may be a virtual camera in the virtual environment, such that adjusting its orientation involves changing the field-of-view (FOV) of that virtual camera. A locomotive action may involve transmitting input control(s) to a separate application, making function calls to an application engine's software development kit (SDK) for controlling a virtual avatar, or the like.

In some cases, a locomotive action may involve changing a character's position and/or orientation by a predefined or predetermined interval. For instance, a locomotive action may involve turning a character to the left or right by a predetermined number of degrees, or might involve moving the character to a different location in the XR environment by a predetermined or specified distance or interval. As described herein, a “predetermined interval” or “default amount” may refer to an amount (e.g., distance, degrees, etc.) and a direction (e.g., left, right, forward, back, or some combination thereof; clockwise or counterclockwise along an axis, etc.), taken together or separately. Put differently, a predetermined interval may specify a translation vector or a spin vector. In some cases, the amount and direction of a predetermined interval may correspond to the extent of a user's hand movement (e.g., the position of a movement location, or turning to the left or right by a discrete interval that relates to how far the user moved their hand to the left or right before performing a release gesture, etc.).

As described herein, the term “gesture” generally refers to one or more hand poses and/or movements that can be recognized, identified, or otherwise determined by an XR system to represent a particular class, category, or type of movement. For instance, a gesture may encompass one or more hand poses and/or movements (e.g., pinching an index finger and thumb, pinching a middle finger and thumb, bringing the pinky, ring, and middle fingers to the palm while extending the index finger and thumb in an L-shape, etc.) that causes an XR system to transition from a general input context to a locomotion input context or mode. A “release gesture” may refer to a gesture that is complementary to the initial gesture (e.g., releasing two pinched fingers, extending the pinky, ring, and middle fingers away from the palm, etc.), such that the initial gesture can be described as “held” until it undone or released.

Embodiments of the disclosed technology may include or be implemented in conjunction with an extra reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Extra reality content may include completely generated content or generated content combined with captured content (e.g., real-world photographs). The extra reality content may include video, audio, haptic feedback, or some combination thereof, any of which may be presented in a single channel or in multiple channels (such as stereo video that produces a three-dimensional effect to the viewer). Additionally, in some embodiments, extra reality may be associated with applications, products, accessories, services, or some combination thereof, that are, e.g., used to create content in an extra reality and/or used in (e.g., perform activities in) an extra reality. The extra reality system that provides the extra reality content may be implemented on various platforms, including a head-mounted display (HMD) connected to a host computer system, a standalone HMD, a mobile device or computing system, a “cave” environment or other projection system, or any other hardware platform capable of providing extra reality content to one or more viewers. “Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Moving and reorienting a representation (e.g., an avatar) of a user in an XR environment is typically achieved by tracking the user's physical movement through a real-world space or using physical input devices like handheld controllers with joysticks. However, these methods of avatar locomotion can be infeasible and impractical. For example, a user may not be able to freely move about a real-world space (e.g., due to a lack of sufficient space, due to an injury or disability, etc.). In addition, some XR systems, such as VR headsets, may be operable without external controllers, such that some users may not possess controllers to enable in-place locomotion in an XR environment. Furthermore, some XR games or applications might be designed to receive user input via hand gestures which, independently, may not be intuitive for a user to correlate to avatar repositioning or reorienting.

Conventionally, the majority of controllers for navigating a representation of a user in an XR environment involves the use of two joysticks on two controllers—one for movement or translation, and the other for reorientation—and therefore require two hands to operate them. Implementations of the XR locomotion system described herein provide specific improvements in the field of XR locomotion in that it can be operated with (i.e., can control a representation's position and orientation using) a single hand, with or without a controller. Further, the XR locomotion system can use intuitive user-understandable visual affordances and controls that easily convey how to move a representation, as well as where and to what degree the representation will move in the XR environment. The XR locomotion system can provide a specific gating function (e.g., looking downward) to display such visual affordances, such that the visual affordances do not otherwise occlude or crowd the XR environment when locomotion is not desired, further conserving battery power, display resources, and processing resources on the XR system. Thus, the XR locomotion system described herein can be used to implement more user-friendly means of locomotive control.

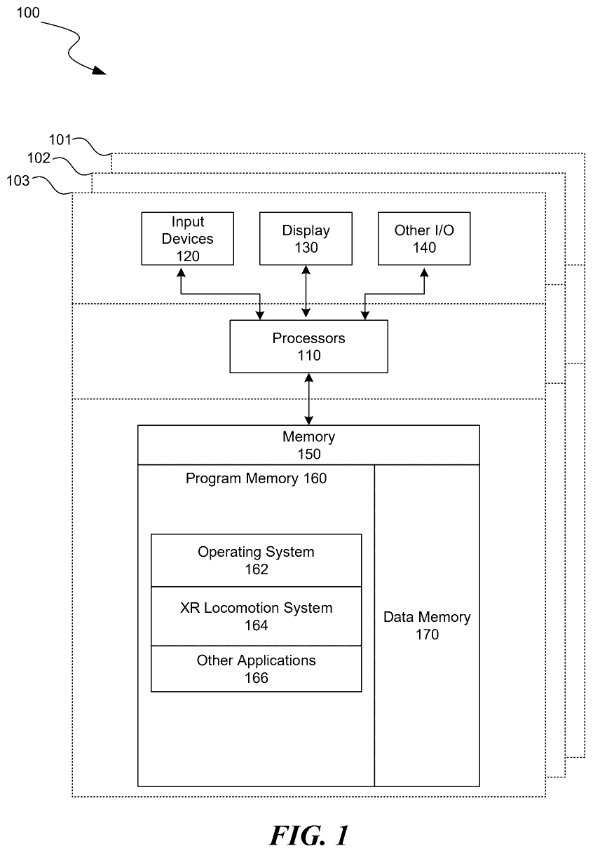

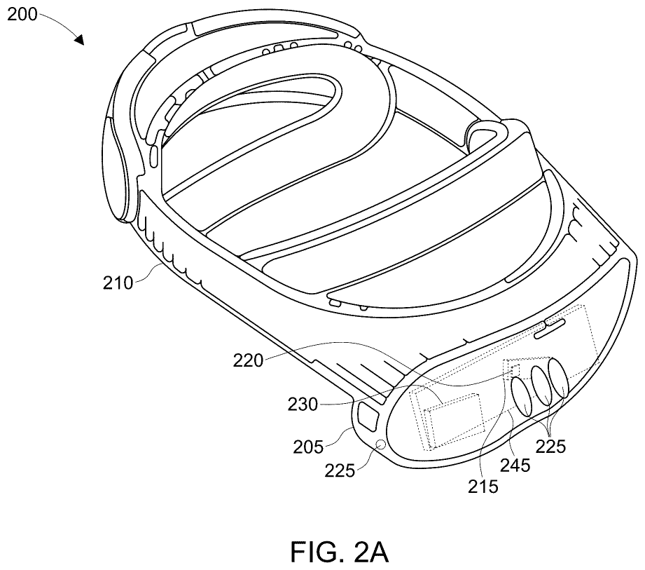

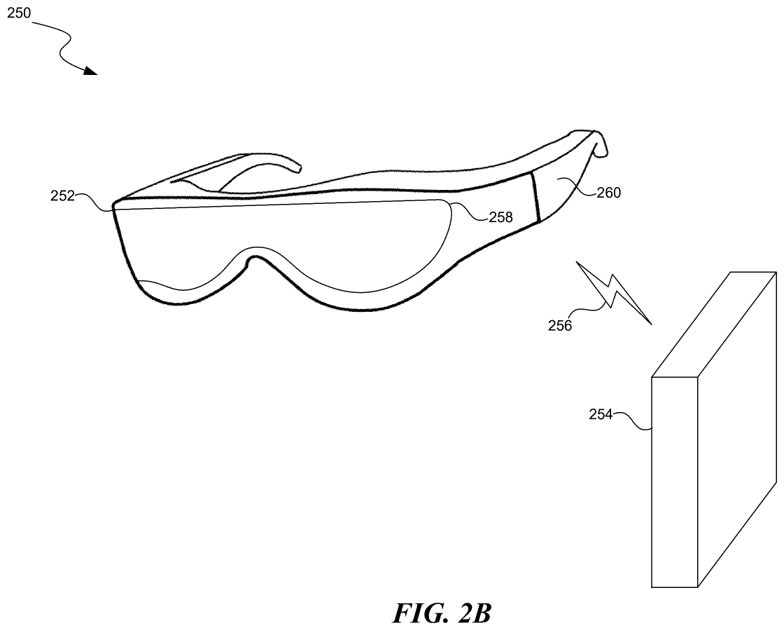

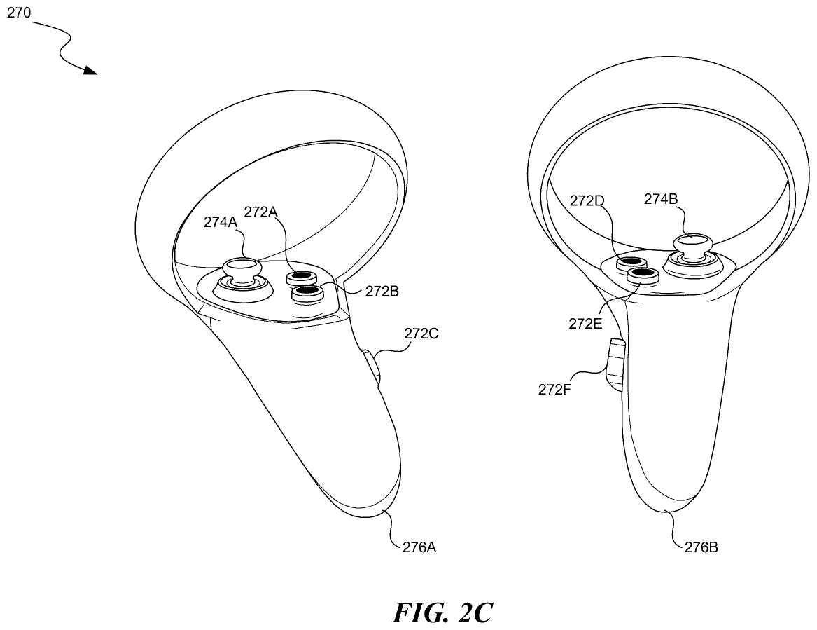

Several implementations are discussed below in more detail in reference to the figures. FIG. 1 is a block diagram illustrating an overview of devices on which some implementations of the disclosed technology can operate. The devices can comprise hardware components of a computing system 100 that can provide locomotion in an extra reality (XR) environment using hand-tracked input. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, XR locomotion system 164, and other application programs 166. Memory 150 can also include data memory 170 that can include, e.g., head position detection data, eye gaze tracking data, gesture detection data, rendering data, visual affordance data, user representation data, orientation data, position data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an extra reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an extra reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

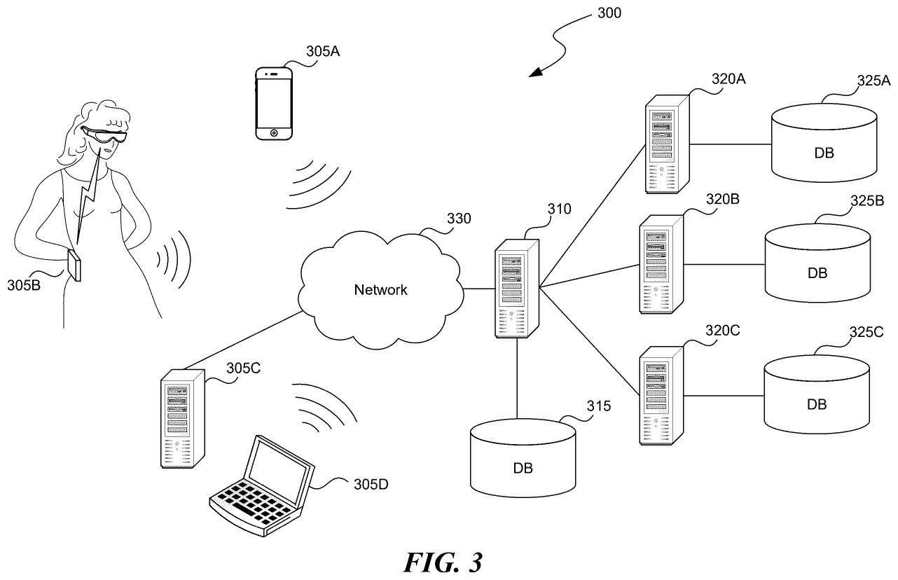

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

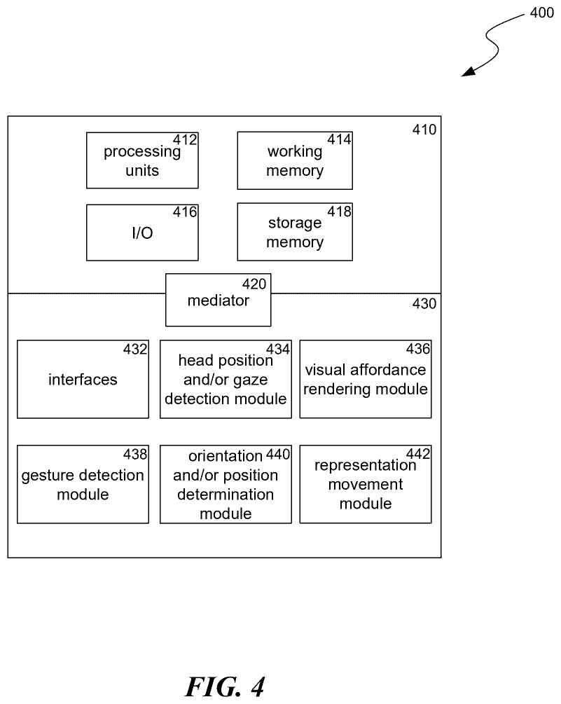

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing locomotion in an extra reality (XR) environment using hand-tracked input. Specialized components 430 can include head position and/or gaze detection module 434, visual affordance rendering module 436, gesture detection module 438, orientation and/or position determination module 440, representation movement module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Head position and/or gaze detection module 434 can detect a downward-facing head position and/or gaze of a user of an XR system. Head position and/or gaze detection module 434 can detect the downward-facing head position and/or gaze by obtaining head position input and/or user gaze input corresponding to a user of an XR system. In some implementations, head position and/or gaze detection module 434 can obtain head position input via one or more cameras, facing away from the user and into the user's real-world environment, capturing one or more images indicating that the user's head is pointed downward. For example, head position and/or gaze detection module 434 can analyze image(s) captured by the XR system to determine that more than a threshold amount of the field-of-view of the camera(s) corresponds to an identified floor and/or ground (such as identified in scene data corresponding to the real-world environment as defined further herein, identified based on a scan and/or model of the real-world environment, identified via object recognition, etc.). In another example, head position and/or gaze detection module 434 can analyze multiple images, taken at subsequent time stamps, and track object(s) in the physical object to determine that the user's head has been moved downward. In still another example, head position and/or gaze detection module 434 can determine that the user's head position has been moved downward via one or more sensors of an inertial measurement unit (IMU), included in the XR system, such as a gyroscope and/or compass.

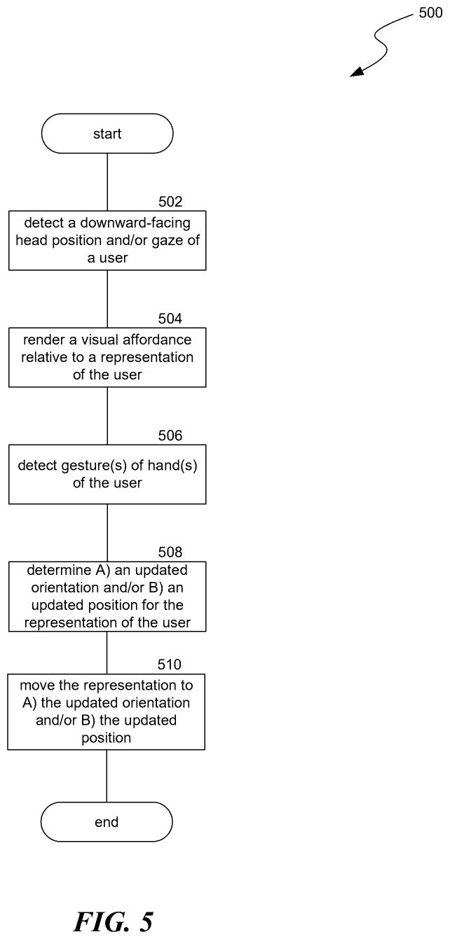

In some implementations, head position and/or gaze detection module 434 can obtain user gaze input from one or more cameras of the XR system facing toward the eyes of the user. The user gaze input can include image(s) of the eye(s) of the user indicative of a gaze direction and/or gaze point in the real-world environment. For example, head position and/or gaze detection module 434 can determine that the user has gazed at or toward their physical feet (or virtual feet of their representation, such as their avatar), at or toward the floor, or otherwise below the XR system for more than a threshold amount of time (e.g., 2 seconds). Although described herein primarily as head position and/or user gaze input, it is contemplated that one or more other types of user input can be received and cause a visual affordance to be rendered as described further herein, such as hand gesture input, button input, audible input, etc. Further details regarding detecting a downward-facing head position and/or gaze of a user of an XR system are described herein with respect to block 502 of FIG. 5.

Visual affordance rendering module 436 can, based on the detected downward-facing head position and/or user gaze by head position and/or gaze detection module 434, render a visual affordance relative to a representation of the user in the XR environment. In other words, the detected downward-facing head position and/or user gaze (and, in some cases, held for a threshold amount of time) can be a gating action for rendering the visual affordance, with the visual affordance not otherwise being rendered. The representation of the user (e.g., an avatar of the user) can have an initial position and initial orientation in the XR environment, providing a viewpoint into the XR environment from that position and orientation. In some implementations, it is contemplated that the representation of the user (or at least a portion thereof) can be rendered in the XR environment on the XR system, while in other implementations, the representation of the user need not be rendered on the XR system. The representation of the user can be rendered at its location in the XR environment, however, on other XR systems accessing the XR environment.

In some implementations, visual affordance rendering module 436 can render the visual affordance in the direction of the head position and/or gaze, e.g., downward and within the field-of-view of the XR system. In some implementations, the visual affordance can be rendered within a threshold distance of the floor or ground (e.g., 0.3 meters). In some implementations, the visual affordance can be rendered within a threshold distance of the user and/or the representation of the user (e.g., 0.5 meters) in the XR environment. In some implementations, the visual affordance can include multiple components, such as one or more movement icons, one or more turning icons, etc. In some implementations, the visual affordance can be a virtual hoop (or portion thereof, such as a semicircle) at least partially encircling the location of the representation of the user in the XR environment. Further details regarding rendering a visual affordance relative to a representation of a user in an XR environment are described herein with respect to block 504 of FIG. 5.

Gesture detection module 438 can detect one or more gestures, of one or more hands of the user, relative to the rendered visual affordance in the XR environment. In some implementation, the gestures can include an ordered series of gestures, with each gesture having separate functionality, as is described further herein. At least one of the gesture(s) can indicate an intent to interact with the rendered visual affordance. In some implementations, the intent can be a proximity of the user's physical hand the visual affordance or a portion thereof (e.g., within a threshold distance, such as 5 cm). In some implementations, the intent can be a gesture toward the visual affordance (or a portion thereof) by the physical hand (and, in some cases, correspondingly by a virtual hand, of the representation of the user, tracking motion of the physical hand). The gesture toward the visual affordance can be a movement of the entire physical hand or can be a movement of a portion of the physical hand toward the visual affordance of a portion thereof (e.g., a pointing of a finger toward the visual affordance, an opening of the fingers toward the visual affordance, a pinching within a threshold distance of the visual affordance, etc.).

Gesture detection module 438 can identify the gesture relative to the visual affordance using, for example, one or more cameras, one or more depth sensors, and/or one or more sensors of an inertial measurement unit (IMU) integral with or in operable communication with the XR device. In some implementations, gesture detection module 438 can perform object recognition and/or apply a machine learning model to identify the particular gesture toward the visual affordance, which, in some implementations, can be indicative of a particular interaction the user wants to take with respect to the visual affordance. For example, a pinch-and-release can indicate an intent to select the visual affordance (or a portion thereof), while a pinch-drag-release can indicate an intent to move the visual affordance (or a portion thereof) to a new location. Further details regarding detecting gesture(s) of hand(s) of a user relative to a rendered visual affordance are described further herein with respect to block 506 of FIG. 5. Although described herein primarily relative to detecting hand gestures via camera(s), it is contemplated that the XR locomotion system described herein can alternatively or additionally detect hand gesture(s) via controller motion(s) and/or selection(s) of button(s) on such controllers, such as a select-and release or a select-drag-release of a controller button relative to the visual affordance.

In some implementations, orientation and/or position determination module 440 can determine an updated orientation, for the representation of the user in the XR environment, in a direction indicated by the detected one or more gestures relative to the rendered visual affordance. In some implementations, orientation and/or position determination module 440 can determine the updated orientation as a default angle or predetermined interval (e.g., 45 degrees), from the initial orientation, in the direction indicated by the gesture(s) (e.g., a pinch-and-release selection of a left or right arrow icon, a pointing posture to the left or right, etc.). In some implementations, orientation and/or position determination module 440 can determine the updated orientation as a custom angle, relative to the initial orientation, the degree to which can be indicated by the gesture(s). For example, a pinch-hold-release of a turn arrow can determine the angle from the initial orientation (e.g., a longer hold, prior to release of the pinch, results in a greater angular change from the initial orientation). In that example, the pinch gesture can select a directional turn arrow icon, the duration of the hold can be correlated to the that angular change from the initial orientation in that direction, and the release can stop increasing the angular change based on the length of the held pinch. In some examples, orientation and/or position determination module 440 can display a preview or other indicator of the default or customized updated orientation, such as a semicircular line (or a turn arrow itself) growing in length as the pinch is held until it is released.

In some implementations, orientation and/or position determination module 440 can determine an updated position, for the representation of the user in the XR environment, at a distance from the initial position indicated by the detected one or more gestures relative to the rendered visual affordance. In some implementations, orientation and/or position determination module 440 can determine the updated position as a default distance, from the initial position, in the direction indicated by the gesture(s). For example, a pinch-and-release selection of a forward arrow and/or a pointing gesture forward, away from the user, can determine the updated position as a default distance or predetermined interval forward from the initial position (e.g., 2 meters). In some implementations, orientation and/or position determination module 440 can determine the updated position as a custom distance, relative to the initial position, with the direction and/or distance being indicated by the gesture(s). For example, the updated position can be determined by a pinch-move-release of a virtual hoop, with the location of the release of the virtual hoop being the updated position. In another example, a pinch-hold-release on a forward arrow can determine the updated position in the forward direction based on the length of the hold of the arrow, similar to that described above. In some examples, orientation and/or position determination module 440 can display a preview or other indicator of the default or customized updated position, such as a rendering of the virtual hoop at the updated position. In some implementations, orientation and/or position determination module 440 can determine both an updated position and an updated orientation by a composite series of gestures relative to the visual affordance, such as a combination of the exemplary gestures and interactions described above. Further details regarding determining A) an updated orientation, B) an updated position, or C) both, for the representation of the user in the XR environment, are described herein with respect to block 508 of FIG. 5.

Representation movement module 442 can move the representation, of the user in the XR environment, A) to the determined updated orientation, B) to the determined updated position, or C) both. The XR system can provide an updated viewpoint into the XR environment from the perspective of the new orientation and/or new position. In some implementations, it is contemplated that the representation may not be moved to the determined updated position, but rather to a location within a threshold distance of the determined updated position, such as when a virtual object is already positioned at the determined updated position, when a particular predetermined physical or virtual object is within the threshold distance of the determined updated position (such that the representation is instead brought on or to the physical or virtual object), etc. From the updated position, it is contemplated that the user can continue to move about the XR environment by the methods described herein and/or by any other methods, such as via a joystick on a controller, by physically moving about the real-world environment, etc. Further details regarding moving a representation, of a user in an XR environment, to an updated orientation, an updated position, or both are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing locomotion in an extra reality (XR) environment using hand-tracked input. In some implementations, process 500 can be performed by an XR system including one or more XR devices, such as an XR head-mounted display (HMD) (e.g., XR HMD 200 of FIG. 2A and/or XR HMD 252 of FIG. 2B), one or more external processing components, one or more controllers (e.g., controllers 276A and/or 276B of FIG. 2C), etc. In some implementations, process 500 can be performed by XR locomotion system 164 of FIG. 1 and/or components 400 of FIG. 4. In some implementations, process 500 can be performed upon detection of a downward-facing head position and/or gaze of a user of the XR system.

In some implementations, at block 502, process 500 can detect a downward-facing gaze of the user of the XR system as gaze input. The gaze input can be indicative of the position of the eye(s) of the user. The gaze input can track movement of at least one eye of a user of the XR system to determine a direction in the real-world environment at which the gaze is directed. For example, process 500 can apply a light source directed to the user's eye which causes multiple reflections around the cornea that can be captured by a camera also directed at the eye. Images from the camera can be used by a machine learning model to estimate an eye position within the user's head.

In some implementations, the gaze input can track movement of both eyes of the user of the XR system, and can further include vergence depth of the eyes to additionally determine a depth in the real-world environment, relative to the user's eye, where the gaze is directed. For example, an eye tracking sub-system can identify a gaze direction relative to an XR head-mounted device (HMD) by modeling one or both of the user's eyes to determine a gaze direction vector, often along the line connecting the user's fovea and the center of the user's pupil, e.g., based on factors such as images capturing a circle of lights (i.e., “glints”) reflected off the user's eye, as noted above. In some implementations, the gaze input can further include a gaze dwell time, e.g., a duration of time for which the user's gaze remains within a threshold distance of a particular location of the real-world environment and/or remains downward-facing. In some implementations, it is contemplated that the images of the eye(s) can be captured by one or more cameras or other image capture devices, integral with or in operable communication with the XR system, facing the eye(s) of the user of the XR system.

In some implementations, at block 502, process 500 can alternatively or additionally detect a downward-facing head position of a user of an XR system. Process 500 can track the position of the user's head, for example, by using camera(s) that track the relative position of a head-mounted display (HMD) with respect to the real-world environment (e.g., capturing subsequent images showing that the cameras are moved downward based on tracked physical objects in the real-world environment, are facing an identified floor in the real-world environment, are facing the user's identified feet in the real-world environment, etc.). In some implementations, process 500 can track the position of the user's head via one or more sensors of an inertial measurement unit (IMU) in the HMD, such as a gyroscope and/or compass.

In some implementations, process 500 can determine whether the gaze direction and/or head position are directed at a location at, or within a threshold distance of, the user's feet or lower body in the real-world environment, the feet or lower body of a representation (e.g., an avatar) of the user in the XR environment, the floor or ground, etc. Process 500 can make this determination by, for example, detecting the head position and/or the direction of the eyes of the user relative to the location of the feet or lower body. For example, process 500 can determine if the vector gaze direction passes through an area of the XR system's display showing the feet and/or lower body of the user or representation, and/or can compute a distance between the point the vector gaze direction passes through the XR system's display and the closest point on the display showing the feet and/or lower body of the user or representation. However, it is contemplated that, in some implementations, the feet and/or lower body of the user and/or representation may not be displayed. For example, the representation of the user may not include virtual feet, a virtual reality (VR) environment may not show the user's real-world feet or lower body, a view of the user or representation's feet or lower body could be occluded by physical and/or virtual objects, etc. In some implementations, process 500 can determine whether the gaze direction and/or head position has moved downward more than a threshold distance, at more than a threshold speed, etc., such as using data collected by an inertial measurement unit (IMU) of the HMD. In some implementations, process 500 can identify the floor or ground within the field-of-view of the XR system, such as using object recognition or other means.

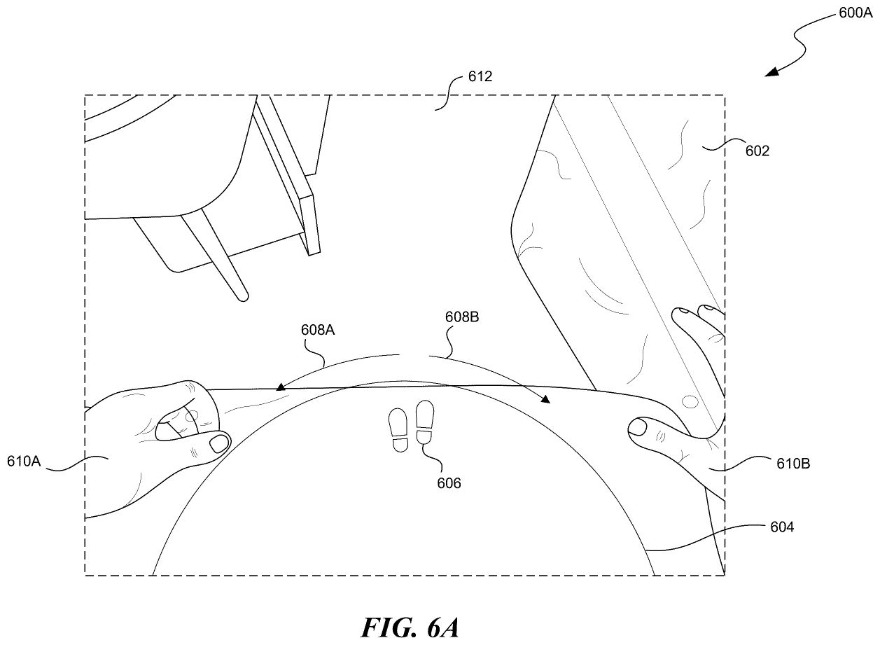

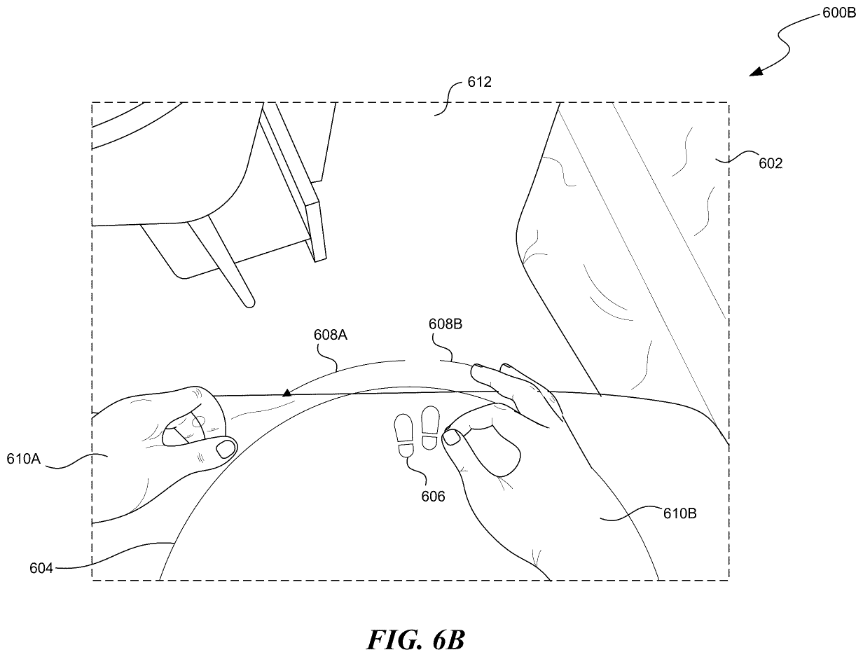

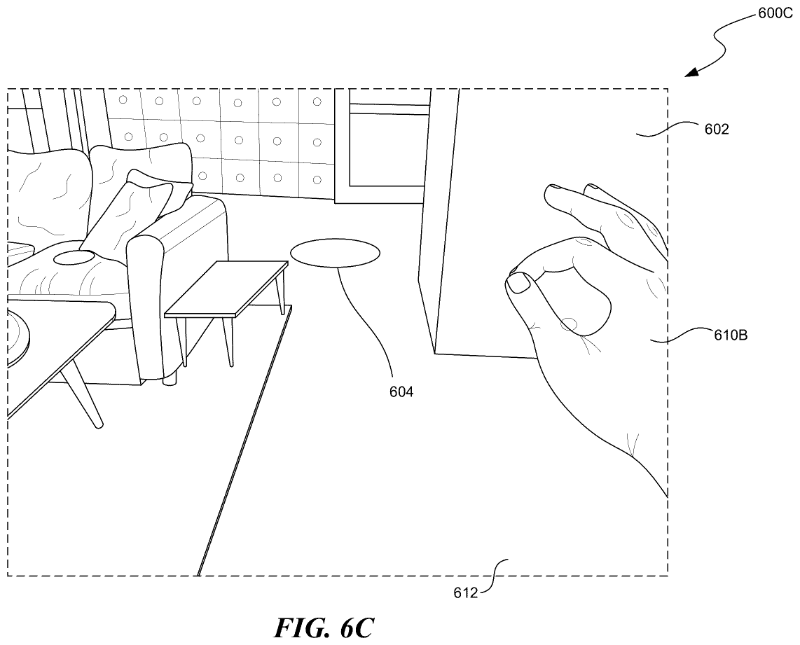

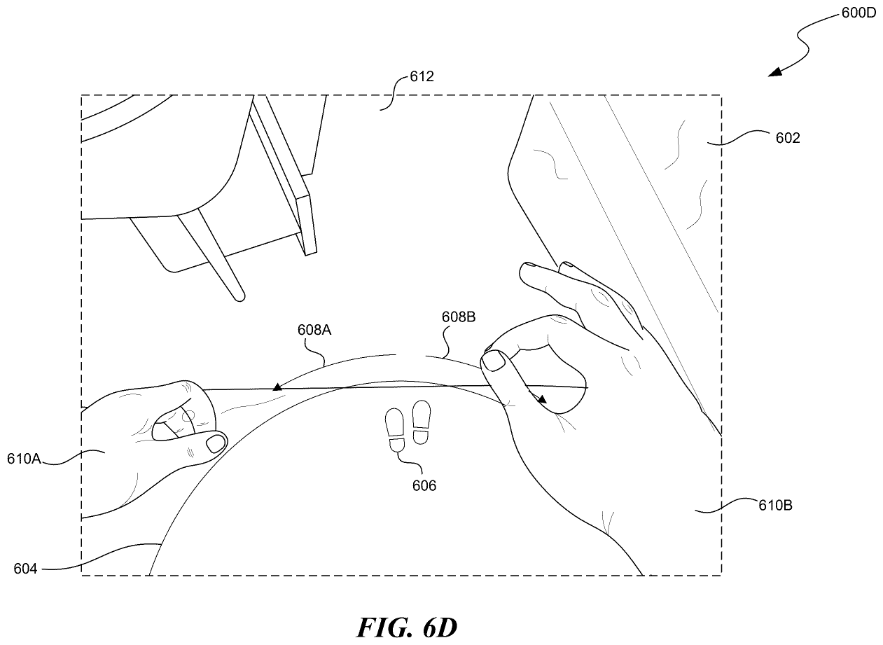

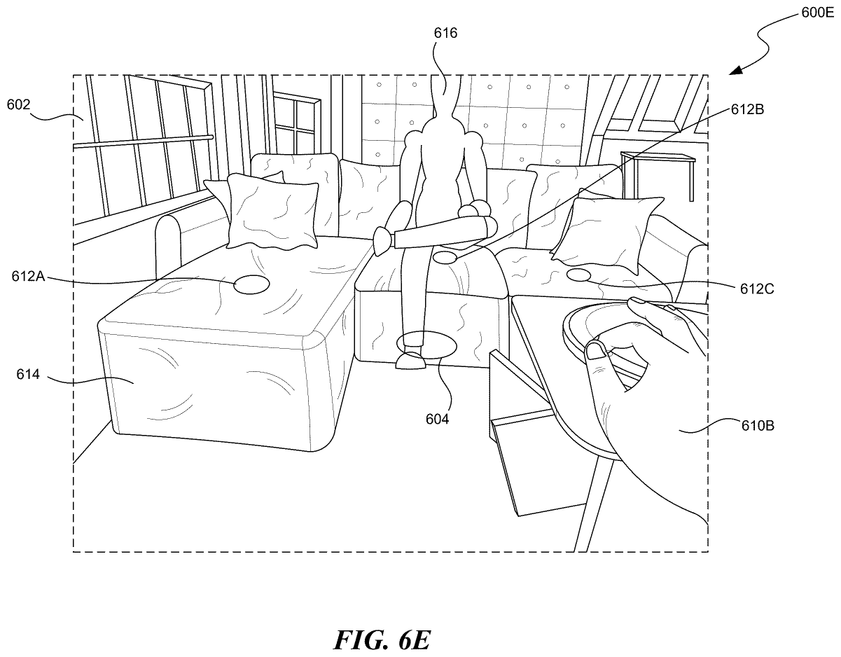

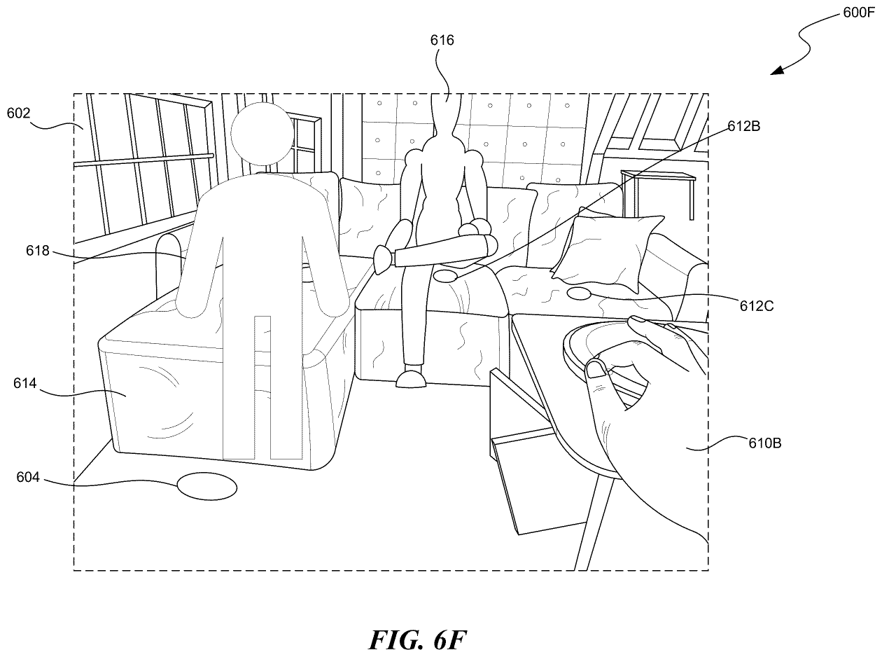

At block 504, process 500 can, based on the detected downward-facing head position and/or gaze, render a visual affordance relative to a representation of the user in the XR environment. The representation of the user can have an initial orientation and initial position in the XR environment, which provides a viewpoint into the XR environment for the user at that orientation and position. In some implementations, process 500 can display the visual affordance based on a further determination that the head position and/or gaze has been detected as downward-facing (and/or directed at the user or representation's feet or the floor) for longer than a threshold amount of time. In some implementations, the visual affordance can be displayed within a threshold distance of the representation in the XR environment. In some implementations, the visual affordance can be displayed below the XR system (e.g., within the user's field-of-view when the head position and/or gaze is facing downward). In one example, the visual affordance can be a virtual hoop or circle (or portion thereof) surrounding at least a portion of the representation of the user. For example, the visual affordance can be a semicircle displayed around the location of the user's and/or representation's feet (e.g., on or within a threshold distance of the floor or ground). In some implementations, the visual affordance can include one or more icons and/or other controls for movement of the representation of the user in the XR environment, such as a movement icon, turn arrows, etc. An exemplary visual affordance is shown and described further herein with respect to FIG. 6A.

At block 506, process 500 can detect one or more gestures, of one or more hands of the user, relative to the rendered visual affordance in the XR environment, as gesture input. Initially, process 500 can identify the physical hand(s) of the user in the real-world environment. In some implementations, process 500 can detect the physical hand of the user via one or more cameras integral with or in operable communication with the XR system. For example, process 500 can capture one or more images of the user's hand in front of the XR system. Process 500 can iteratively track the position of the user's hand as it relates to a coordinate system of the XR environment. In some implementations, process 500 can use a machine learning model to identify the physical hand from the image(s). For example, process 500 can train a machine learning model with images capturing known hands, such as images showing various users' hands in various positions. Process 500 can identify relevant features in the images, such as edges, curves, and/or colors indicative of hand. Process 500 can train the machine learning model using these relevant features of known hands and position/pose information. Once the model is trained with sufficient data, process 500 can use the trained model to take relevant features for newly captured image(s) provide position information. For example, process 500 can apply a machine learning system trained to determine a position and/or pose of the hands in the environment or relative to the XR system, which can then be translated into the XR system's coordinate system.

In some implementations, the gesture input can be alternatively or additionally captured by one or more electromyography (EMG) sensors, such as may be included in a wearable device (e.g., a smart bracelet or smart watch) in operable communication with the XR system. In some implementations, the gesture input can be captured by one or more controllers of the XR system. In some implementations, the gesture input can alternatively or additionally be captured by one or more depth sensors and/or one or more sensors of an inertial measurement unit (IMU) integral with or in operable communication with the XR system.

In some implementations, process 500 can determine that the one or more gestures indicate an intent to interact with one or more portions of the rendered visual affordance. In some implementations, determining the intent to interact can include determining that a gesture is made in proximity of (e.g., within a threshold distance of) or toward the rendered visual affordance (or a portion thereof, such as a movement icon, a turn arrow, etc.). In some implementations, determining the intent to interact can include another indication of interaction with the visual affordance, with or without coming within a threshold distance of or toward the visual affordance, such as pointing at the visual affordance (e.g., at least one finger of the hand extending toward the visual affordance).

Process 500 can identify the gesture in proximity of and/or toward the visual affordance by, for example, using one or more cameras as discussed above. The one or more cameras can capture images of the physical hand moving toward a location in the XR environment corresponding to the visual affordance (or portion thereof). In some implementations, process 500 can identify a gesture away from the user and toward the visual affordance (or portion thereof) using one or more depth sensors integral with or in operable communication with the XR system. In some implementations, the gesture can include a particular posture of the physical hand, such as a pointing posture, an open hand posture, a grabbing posture, a pinching posture, a dragging posture, a release of a posture (e.g., a pinching posture to an open hand posture), etc. As described herein, a “pinch, “pinch gesture,” and/or “pinch posture” can correspond to a hand posture in which at least one finger contacts, or is within a threshold distance of contacting, the thumb of the same hand. In some implementations, process 500 can identify the posture of the hand similarly to how process 500 identifies the physical hand, such as by capturing images and performing object recognition, using machine learning models trained on images of particular hand postures, etc.

Although described primarily herein as using gesture(s) to determine an intent to interact, it is contemplated that, in some implementations, the user's intent to interact with the visual affordance can alternatively or additionally include one or more other forms of user input. For example, the user input can be selection of a physical button on the XR system and/or virtual button displayed by the XR system (e.g., via a hand or via a controller). In some implementations, the intent to interact can be based on gaze input, e.g., the user gazes at the visual affordance (or a portion thereof) for longer than a threshold amount of time, determined in a similar manner to that described above. In some implementations, the user input can include audible input indicative of one or more words spoken by the user of the XR system. In some implementations, the audible input can be captured by, for example, one or more microphones integral with or in operable communication with the XR system. In some implementations, process 500 can transcribe the audible input and perform natural language processing techniques to convert the audible input into a machine-readable textual format. In some implementations, the user input can include any combination of button input, gaze input, gesture input, and/or audible input.

In some implementations, at block 508, process 500 can determine an updated orientation, for the representation of the user, in a direction indicated by the detected one or more gestures relative to the rendered visual affordance. For example, if the gesture(s) relative to the visual affordance indicate that the user desires to turn to the left (e.g., grabbing and rotating the virtual hoop to the left, selection of a rendered left turn arrow, etc.), process 500 can determine the updated orientation based on the gesture(s). In some implementations, process 500 can determine the updated orientation as a default orientation relative to the initial orientation based on the gesture(s) (e.g., 30 degrees to the left or right, based on which direction the gesture(s) indicate). Exemplary gesture(s) made relative to a visual affordance to turn a default amount in an XR environment are shown and described further herein with respect to FIG. 10A. In some implementations, process 500 can determine a specific updated orientation relative to the initial orientation based on the gesture(s) (e.g., a pinch-and-hold on a left turn arrow can move the orientation to the left to a degree determined by how long the pinch is held, a greater pinch-and-rotate angle of the virtual hoop can cause the updated orientation to be a corresponding angle relative to the initial orientation, etc.). An exemplary gesture made relative to a visual affordance to turn an amount in an XR environment are shown and described further herein with respect to FIG. 6D.

In some implementations, at block 508, process 500 can determine an updated position, for the representation of the user, at a distance, from the initial position, indicated by the detected one or more gestures relative to the rendered visual affordance. For example, a user can perform pinch-drag-release gestures on the visual affordance (or a portion thereof), with the location of the release of the visual affordance corresponding to the updated position in the XR environment. In another example, the user can pinch-and-release on a forward arrow on of a movement icon of the visual affordance, which can move the representation of the user forward in the XR environment a default amount (e.g., 3 meters). In some implementations, process 500 can determine the distance from the initial orientation based on the gesture(s) (e.g., a pinch-and-hold on a forward arrow can move the position forward a distance determined by how long the pinch is held).

In some implementations, process 500 can “snap” the updated position to a particular location in the XR environment, such as a location corresponding to a particular physical object or virtual object in the XR environment (e.g., a “hot spot”). For example, if the gesture(s) correspond to movement at or within a threshold distance of the hot spot, the updated position can be selected to be at the hot spot, which, in some cases, results in the updated position being at the hot spot instead of at the location corresponding to the gesture(s). In some implementations, in “snapping” the updated position to the hot spot, process 500 can further determine an updated orientation for the representation of the user defined by one or more constraints associated with the location, physical object, and/or virtual object. For example, if the hot spot corresponds to a physical couch facing the user in the real-world environment, and based on a gesture indicating movement within a threshold distance of the couch, process 500 can snap the representation of the user to the couch, and reorient the user to be sitting on the couch. In some implementations, physical objects in the real-world environment, their locations, and/or such constraint(s) relative to physical object(s) can be defined by or in association with scene data for the real-world environment. Further details regarding capturing and/or obtaining scene data for a real-world environment are described in U.S. patent application Ser. No. 18/069,029, filed Dec. 20, 2022, entitled “Shared Scene Co-Location for Artificial Reality Devices,” which is herein incorporated by reference in its entirety. In some implementations, it is contemplated that a machine learning model can identify constraint(s) corresponding to a particular physical object based on characteristics of the object included in the scene data, such as a semantic label for the physical object, and/or based on identification of the object via object recognition techniques. In some implementations, constraint(s) for virtual object(s) can be defined by the XR application or system managing the virtual object(s), such as in metadata associated with the virtual object(s).

In some implementations, upon determining that the gesture(s) correspond to movement within a threshold distance of a hot spot, process 500 can further determine that a particular hot spot, or portion thereof, is unavailable for rendering of the representation of the user. For example, the constraint(s) associated with the hot spot can specify a maximum number of representation(s) and/or other virtual object(s) that can be located at the hot spot, can specify that no representation(s) and/or other virtual object(s) can be located at the hot spot, can specify that only particular representation(s) and/or other virtual object(s) can be located at the hot spot (e.g., virtual objects or a particular type or having certain characteristics, etc.). For example, a physical couch having a hot spot at each cushion can allow only one representation or other virtual object to be rendered at each hot spot. Process 500 can then determine the updated position as a further position within a same or different threshold distance of the hot spot, or the portion thereof, which, in some implementations, may correspond to a further hot spot (e.g., an adjacent hot spot corresponding to an adjacent cushion that is not already occupied). In some implementations, process 500 can render a preview of the representation of the user at the hot spot upon determining the updated position and/or updated orientation for the representation of the user. An exemplary preview of a representation of a user at a hot spot, of multiple hot spots, is shown and described further herein with respect to FIG. 6E. An exemplary preview of a representation of a user at a further hot spot, within a threshold distance of an initially determined hot spot, is shown and described further herein with respect to FIG. 6F.

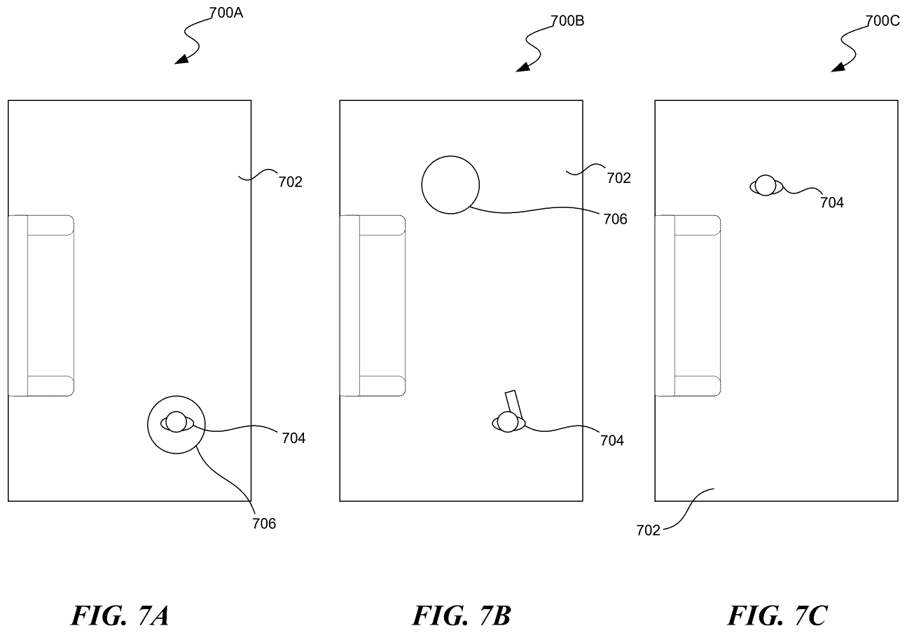

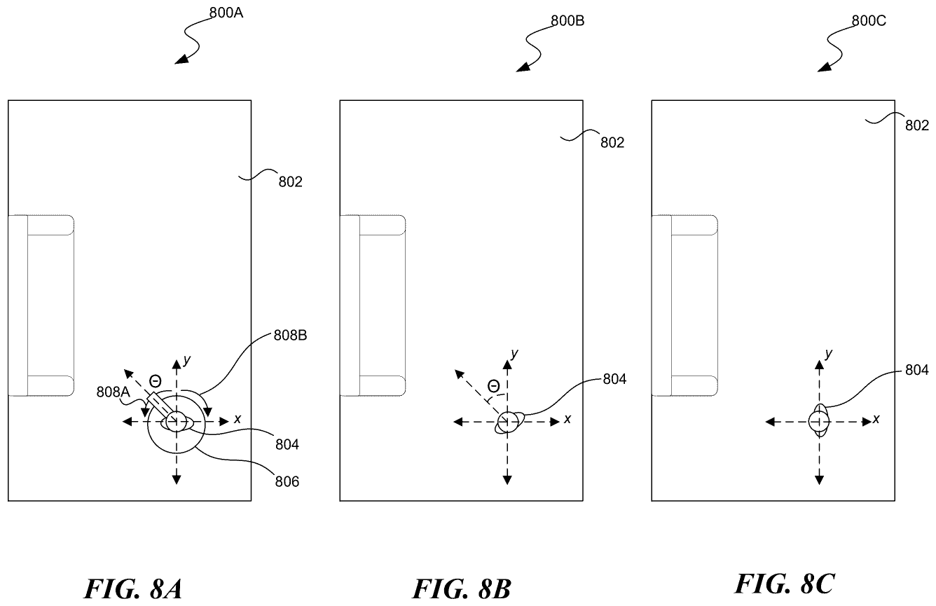

When an updated orientation is determined at block 508, process 500 can move the representation, of the user in the XR environment, to the determined updated orientation at block 510. Exemplary views of moving a representation of a user to an updated orientation in an XR environment are shown and described further herein with respect to FIGS. 8A-8C. When an updated position is determined at block 508, process 500 can move the representation, of the user in the XR environment, at or within a threshold distance of the determined updated position at block 510. Exemplary views of moving a representation of a user to an updated position in an XR environment are shown and described further herein with respect to FIGS. 7A-7C. Thus, the user can have a viewpoint, into the XR environment, from the updated orientation and/or position.

FIGS. 6A-6F are conceptual diagrams illustrating exemplary views 600A-600F, from an XR system, of a virtual hoop and manipulation of the virtual hoop by a user of the XR system. Specifically, FIG. 6A is a conceptual diagram illustrating an example view 600A, from an XR system, of a virtual hoop 604 displayed in response to a user looking downward (e.g., moving their head and/or gaze downward toward floor 612 of XR environment 602). In this example, virtual hoop 604 can be a virtual circle or semicircle at least partially encircling the position of a representation of the user (e.g., an avatar having virtual hands 610A-610B tracking movement of the user's real-world hands and/or controllers) in XR environment 602. Virtual hoop 604 can further include movement icon 606, left turn arrow 608A, and right turn arrow 608B. In this example, movement icon 606 can be displayed within virtual hoop 604 toward the representation of the user, while turn arrows 608A-608B can be displayed outside virtual hoop 604 and follow the curvature of virtual hoop 604 in corresponding left and right directions.

FIGS. 6B-6C are conceptual diagrams illustrating example views 600B-600C, from an XR system, of a representation of a user changing position in an XR environment by moving a virtual hoop 604. As shown in view 600B, the user can make a pinch gesture with their physical hand (shown as virtual hand 610B which can track movement and/or gestures of the real-world hand) within a threshold distance of movement icon 606. As shown in view 600C, the user can then look up (e.g., gaze upward and/or move the head upward) and move their hand (being tracked by virtual hand 610B) to move virtual hoop 604 to another location in XR environment 602. In this example, movement of virtual hand 610B a particular distance in XR environment 602 can cause movement of virtual hoop 604 a greater distance (e.g., movement of virtual hand 610B by 0.5 meters can move virtual hoop 604 3 meters), such as according to a ratio, a look up table, exponentially, etc. Upon releasing the pinch gesture by virtual hand 610B, the representation of the user can be moved to the new location of virtual hoop 604 when the pinch was released, such that the user has a viewpoint into XR environment 602 from the new location. In this example, at the new location of virtual hoop 604, the representation of the user can maintain its same orientation as at the original position of virtual hoop 604.

Changing position within an XR environment by manipulating a virtual hoop is further described herein with references to FIGS. 7A-7C. FIGS. 7A-7C are block diagrams illustrating overhead views 700A-700C of a representation 704 of a user (e.g., an avatar) changing position in an XR environment 702 by moving a virtual hoop 706. A shown in view 700A, the user can look downward and/or move their head downward, displaying virtual hoop 706 in XR environment 702. As shown in view 700B of FIG. 7B, the user can select virtual hoop 706 or a portion thereof, such as a movement icon, via a pinching or grabbing gesture of the hand. The user can then move virtual hoop 706 to a new position by outstretching their arm. As shown in view 700C, upon releasing the gesture with virtual hoop 706 at its new position shown in view 700B, representation 704 can be moved to the new position in the XR environment.

Turning back to FIG. 6D, FIG. 6D is a conceptual diagram illustrating an example view 600D, from an XR system, of a representation of a user interacting with a virtual hoop 604 to change orientation in an XR environment 602. As shown in view 600D, the user can make a pinch gesture with their physical hand (which can be tracked by virtual hand 610B) within a threshold distance of right turn arrow 608B. As described further herein with respect to FIGS. 8A-8C, different gesture combinations relative to right turn arrow 608B can cause different amounts of change in orientation for the representation of the user.

FIGS. 8A-8C are block diagrams illustrating overhead views 800A-800C of a representation 804 of a user changing orientation in an XR environment 802 by interacting with a virtual hoop 806, virtual hoop 806 including left arrow 808A and right arrow 808B. As shown in view 800A, the user can perform a pinch gesture with their hand (in this example, the left hand) within a threshold distance of left arrow 808A. In this example, the user can make the pinch gesture at an angle, Θ, from their initial orientation. y. In one example, the user can make a pinch-and-release gesture (e.g., bringing the pointer finger and thumb together for less than a threshold amount of time, such as 0.5 seconds, then separating the finger and thumb) at the angle, Θ, on or within a threshold distance of left arrow 808A, which can cause a corresponding orientation change of representation 804 to the left by the angle, Θ, as shown in view 800B. In another example, the user can make a pinch gesture on left arrow 808A, then move the pinch gesture (which, in some cases, can correspondingly move left arrow 808A) the angle, Θ, which can cause a corresponding orientation change of representation 804 to the left by the angle, Θ, as shown in view 800B. In still another example, the user can make a pinch-and-release gesture within a threshold distance of left arrow 808A, which can cause a default change in orientation to the left, such as 90 degree counterclockwise angular movement of representation 804, as shown in view 800C of FIG. 8C, regardless of the angle, Θ, at which the gesture is made and/or released.

Turning back to FIG. 6E, FIG. 6E is a conceptual diagram illustrating an example view 600E, from an XR system, of a preview 616 of a position and orientation of a representation of user relative to a virtual object 614 based on an interaction with a virtual hoop 604. As described further herein, virtual object 614 (in this example, a virtual couch) can have designated “hot spots” 612A-612C to which the representation of the user can be snapped in XR environment 602. Relative to view 600B of FIG. 6B, the user can use their hand (corresponding to virtual hand 610B) to pinch and move virtual hoop 604 within a threshold distance of virtual object 614 in XR environment 602 (e.g., 2 meters), which can cause display of hot spots 612A-612C. The user can further move the pinch gesture of their hand (tracked by virtual hand 610B), without releasing, within another threshold distance of hot spot 612B (e.g., 0.5 meters), which can cause preview 616 to display. Preview 616 can indicate the position and orientation of the representation of the user at that hot spot 612B, from which the user will be provided a viewpoint into XR environment 602 if the gesture is released at that location.

FIG. 6F is a conceptual diagram illustrating an example view 600F, from an XR system, of a preview 616 of a suggested position and orientation of a representation of a user relative to a virtual object 614 based on interaction with a virtual hoop 604. As shown in view 600F, the user can use their hand (corresponding to virtual hand 610B) to pinch and move virtual hoop 604 within a threshold distance of virtual object 614 in XR environment 602, which can cause display of hot spots 612A-612C. The user can further move the pinch gesture within a threshold distance of hot spot 612A (shown in view 600E). However, hot spot 612A can already be occupied by representation 618 of another user accessing XR environment 602 (e.g., hot spot 612A can be previously defined as having a maximum number of one representation or other virtual object at its location). Thus, the XR system can determine another hot spot 612B, which is available and within another threshold distance of hot spot 612A (or the closest available hot spot to hot spot 612A), and render preview 616 of the representation of the user at the suggested position and orientation relative to hot spot 612B, from which the user will be provide a viewpoint into XR environment 602 if the gesture is released at that location.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing locomotion in an extra reality environment using hand-tracked input, the method comprising:
detecting a downward-facing head position and/or gaze of a user of an extra reality system;
based on the detected downward-facing head position and/or gaze, rendering a visual affordance relative to a representation of the user in the extra reality environment, wherein the representation of the user has an initial orientation and initial position in the extra reality environment;
detecting one or more gestures, of one or more hands of the user, relative to the rendered visual affordance in the extra reality environment;
determining A) an updated orientation, for the representation of the user, in a direction indicated by the detected one or more gestures relative to the rendered visual affordance, B) an updated position, for the representation of the user, at a distance from the initial position indicated by the detected one or more gestures relative to the rendered visual affordance, or C) both; and
moving the representation, of the user in the extra reality environment, A) to the determined updated orientation, B) at or within a threshold of the determined updated position, or C) both.

2. The method of claim 1, wherein the visual affordance includes a virtual hoop surrounding the representation, of the user in the extra reality environment, positioned below the extra reality system.

3. The method of claim 2, wherein the visual affordance further includes a movement icon and multiple turn arrows.

4. The method of claim 3,
wherein the updated position is determined,
wherein the representation is moved from the initial position to the determined updated position,
wherein the one or more gestures includes a grab, drag, and release of the virtual hoop via the movement icon, and
wherein the distance of the updated position from the initial position is based on a location of the release of the virtual hoop via the movement icon.

5. The method of claim 3,
wherein the updated orientation is determined,
wherein the representation is moved from the initial orientation to the determined updated orientation,
wherein the one or more gestures includes a pinch and release of the virtual hoop via a turn arrow of the multiple turn arrows, and
wherein the determined updated orientation is a default angle, from the initial orientation, in the direction indicated by the turn arrow.

6. The method of claim 3,
wherein the updated orientation is determined,
wherein the representation is moved, from the initial orientation to the determined updated orientation, in the direction indicated by the detected one or more gestures relative to the virtual hoop,
wherein the one or more gestures includes a pinch, drag, and release of the virtual hoop via a turn arrow of the multiple turn arrows, and
wherein the determined updated orientation is an angle, from the initial orientation, in the direction indicated by the turn arrow, the angle corresponding to a location of the release of the virtual hoop via the turn arrow.

7. The method of claim 1,
wherein the updated position is determined, and
wherein the method further comprises:
upon detecting at least one gesture of the one or more gestures, and before moving the representation in the extra reality environment, rendering a preview of the representation, of the user, at the determined updated position.

8. The method of claim 7, wherein the rendering the preview is based on a determination that the updated position corresponds to a predefined object in the extra reality environment.

9. The method of claim 8, wherein, based on the determination that the updated position corresponds to the predefined object in the extra reality environment, the moving the representation includes reorienting the representation relative to the predefined object.

10. The method of claim 1,
wherein the updated position is determined, and
wherein the method further comprises:
upon detecting at least one gesture of the one or more gestures, and before moving the representation in the extra reality environment, determining that the updated position corresponds to an object, in the extra reality environment, that is unavailable for rendering of the representation of the user,
wherein, based on the determining that the updated position corresponds to the object that is unavailable for rendering of the representation, the representation is moved within the threshold of the updated position instead of at the updated position.

11. The method of claim 10,
wherein the determining that the updated position corresponds to the object that is unavailable, for rendering of the representation of the user, is based on a maximum number of virtual objects rendered relative to the object.

12. A computer-readable storage medium storing instructions, for providing locomotion in an extra reality (XR) environment using hand-tracked input, the instructions, when executed by a computing system, cause the computing system to:
detect a downward-facing head position and/or gaze of a user of an XR system;
based on the detected downward-facing head position and/or gaze, render a visual affordance relative to a representation of the user in the XR environment, wherein the representation of the user has an initial orientation and initial position in the XR environment;
detect one or more gestures, of one or more hands of the user, relative to the rendered visual affordance in the XR environment; and
move the representation, of the user in the XR environment, to A) an updated orientation at an angle, relative to the initial orientation, indicated by the detected one or more gestures, B) an updated position at a distance, relative to the initial position, indicated by the detected one or more gestures, or C) both.

13. The computer-readable storage medium of claim 12, wherein the visual affordance includes a virtual hoop surrounding the representation, of the user in the XR environment, positioned below the XR system.

14. The computer-readable storage medium of claim 12, wherein the visual affordance includes a movement icon and multiple turn arrows.

15. The computer-readable storage medium of claim 12,
wherein the updated position is determined,
wherein the representation is moved from the initial position to the updated position,
wherein the one or more gestures includes a grab, drag, and release of the visual affordance, and
wherein the distance of the updated position from the initial position is based on a location of the release of the visual affordance.

16. A computing system for providing locomotion in an extra reality (XR) environment using hand-tracked input, the computing system comprising:
one or more processors; and
one or more memories storing instructions that, when executed by the one or more processors, cause the computing system to:
detect a downward-facing head position and/or gaze of a user of an XR system;
based on the detected downward-facing head position and/or gaze, render a visual affordance relative to a representation of the user in the XR environment, wherein the representation of the user has an initial orientation and initial position in the XR environment;
detect one or more gestures, of one or more hands of the user, relative to the rendered visual affordance in the XR environment; and
move the representation, of the user in the XR environment, to A) an updated orientation at an angle, relative to the initial orientation, indicated by the detected one or more gestures, B) an updated position at a distance, relative to the initial position, indicated by the detected one or more gestures, or C) both.

17. The computing system of claim 16,
wherein the updated position is determined, and
wherein the instructions, when executed by the one or more processors, further cause the computing system to:
upon detecting at least one gesture of the one or more gestures, and before moving the representation in the XR environment, render a preview of the representation, of the user, at the updated position.

18. The computing system of claim 17, wherein the rendering the preview is based on a determination that the updated position corresponds to a predefined object in the XR environment.

19. The computing system of claim 18, wherein, based on the determination that the updated position corresponds to a predefined object in the XR environment, the moving the representation includes reorienting the representation relative to the predefined object.

20. The computing system of claim 16,
wherein the updated position is determined, and
wherein the instructions, when executed by the one or more processors, further cause the computing system to:
upon detecting at least one gesture of the one or more gestures, and before moving the representation in the XR environment, determine that the at least one gesture corresponds to a point on an object, in the XR environment, that is unavailable for rendering of the representation of the user,
wherein, based on the determining that the at least one gesture corresponds to the point on the object that is unavailable for rendering of the representation, the representation is moved to the updated position, the updated position being within a threshold distance of the point on the object.
